(19) United States
(12) Patent Application Publication
(10) Pub. No.: US 2011/0121823 A1
(43) Pub. Date: May 26, 2011

(54) MESHING ENCODER GEAR AND SENSOR ASSEMBLY

(75) Inventor: Jesse B. Bradley, Royal Oak, MI (US)

(73) Assignee: GM GLOBAL ENCODER GEAR AND SENSOR ASSEMBLY, Detroit, MI (US)

(21) Appl. No.: 12/625,296

(22) Filed: Nov. 24, 2009

(51) Int. Cl. G01B 7/30

(52) U.S. Cl. 324/207.2

(57) ABSTRACT

A sensor assembly for a transmission includes a meshing encoder gear and an unbiased sensor. The gear teeth of the encoder gear have target surfaces that generate a magnetic field. The sensor targets the magnetized target surfaces to detect the magnetic field or the change in the magnetic field and sends a signal to a controller that is converted to a speed measurement of the encoder gear.

### FIELD

The present disclosure relates to meshing gears and sensors as used in mechanical devices, and more particularly to gears and sensor assemblies as incorporated into automobile transmissions.

### BACKGROUND

The statements in this section merely provide background information related to the present disclosure and may or may not constitute prior art.

In mechanical devices such as power transmissions, engines or other machines, efficient control of the operation of the device often relies on a controller receiving data from sensors within the device. A transmission controller, for example, may require the rotational speed of an internal gear, shaft or other rotating member. Typically, this is accomplished using an encoder wheel rotationally secured to such a shaft or member and a sensor targeting the encoder wheel. The encoder wheel is required as an additional part to the gears or shafts that are already utilized in the device. The encoder wheel includes target teeth that are detected by the sensor as they rotate pass the sensor. The sensor is positioned to target the radial surface of the teeth of the encoder wheel. The sensor is typically of a biased type and includes a magnet and is more costly than an unbiased sensor. The encoder wheel and sensor assembly requires additional parts and enlarged packaging space.

Accordingly, there is room in the art for a combined encoder wheel, gear and sensor assembly that reduces the number of parts required, simplifies the complexity of the sensor and improves packaging, weight and configuration of the assembly.

### SUMMARY

An encoder gear and sensor assembly for sensing the speed of the encoder gear is provided, the sensor assembly including a housing, a first shaft rotatably supported by the housing, a first gear having a plurality of gear teeth with each having a target surface and wherein the first gear is rotatably supported by the first shaft and a sensor mounted to the housing and wherein the sensor has a first end opposing the target surfaces of the plurality of gear teeth. The target surface of the plurality of gear teeth of the first gear generates a magnetic field.

In one example of the present invention, the sensor assembly includes a second shaft rotatably supported by the housing, a second gear including a plurality of gear teeth. The second gear is rotatably supported by the second shaft. The plurality of gear teeth of the second gear are intermeshed with the plurality of gear teeth of the first gear.

In another example of the present invention, the target surface of the plurality of gear teeth of the first gear includes a coating having a magnetic material that generates the magnetic field.

In yet another example of the present invention, the target surface of the gear teeth of the first gear are formed of a magnetic material.

In yet another example of the present invention, the magnetic field of the target surfaces of consecutive gear teeth alternate polarity.

In yet another example of the present invention, the sensor is unbiased.

In yet another example of the present invention, the first gear is a spur gear.

In yet another example of the present invention, the first gear is a helical gear.

Further objects, aspects and advantages of the present disclosure will become apparent by reference to the following description and appended drawings wherein like reference numbers refer to the same component, element or feature.

### DRAWINGS

The drawings described herein are for illustration purposes only and are not intended to limit the scope of the present disclosure in any way;

FIG. 1 is a plan view of an example of a meshing encoder gear and sensor assembly according to the present disclosure; and

FIG. 2 is a perspective view of one example of an encoder gear according to the present disclosure.

### DETAILED DESCRIPTION

The following description is merely exemplary in nature and is not intended to limit the present disclosure, application, or uses.

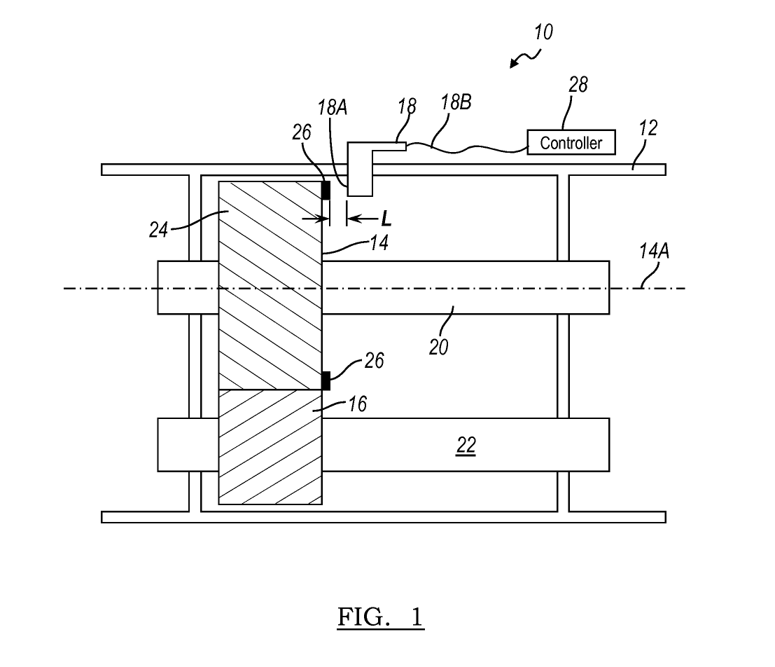

Referring to the drawings, wherein like reference numbers refer to like components, in FIG. 1 an example of a meshing encoder gear and sensor assembly 10 according to the present invention is illustrated. The gear and sensor assembly 10 includes a housing 12, an encoder gear 14, a pinion gear 16 and a sensor 18. More specifically, the encoder gear 14 and pinion gear 16 are each rotatably supported by a pair of shafts 20, 22 which are rotatably supported by the housing 12. The encoder gear 14 includes a plurality of gear teeth 24 each having a target surface 26 extending in a direction perpendicular with the axis of rotation 14A of the encoder gear 14. The target surface 26 of each gear tooth 24 is magnetized to generate a magnetic field.

The sensor 18 is fixed or securely attached to a wall 12A of the housing 12. The sensor 18 has an end 18A that generates as signal induced by the rotation of the encoder gear 14. The signal is an electrical current that is created by the movement of the magnetized target surface 26 of the gear tooth 24 past sensor end 18A. The sensor 18 may be of various types without departing from the scope of the present invention. Examples of suitable sensors 18 include, but are not limited to, unbiased type sensors and Hall Effect type sensors. In accordance with one example of the present invention, the sensor 18 is of the unbiased type which does not include a magnet. Internally, the sensor 18 includes a wire coil wrapped around a ferrous core. The ends of the coil are extended to a wire lead 18B which is connected to a controller 28. The sensor 18 is positioned such that the sensor end 18A is within close proximity to the encoder gear 14. The distance between the encoder gear 14 and the sensor end 18A creates an air gap “L”. As the magnetized target surface 26 of a gear tooth 24 comes into close proximity of the sensor end 18A, the magnetic field emanating from the target surface 26 passes through the sensor 18. The continuous rotation of the encoder gear 14, and thus the passage of gear teeth 24 past the sensor 18, causes the sensor 18 to experience a continuous change of the magnetic flux. The change in the magnetic flux in the ferrous core of the sensor 18 induces a voltage in the coil of the sensor 18. The voltage induced in the coil generates a voltage signal current that is received by the controller 28. As the encoder gear 14 rotates, the change in magnetic flux in the sensor 18 generates a signal indicative of varying voltage. The magnitude of the voltage signal is proportional to the rate of change of the magnetic flux induced in the sensor 18. For example, if the encoder gear 14 is rotating slowly, the rate of change of the magnetic flux in the sensor 18 is less and the resulting voltage magnitude will be lower. However, if the encoder gear 14 is moving at a higher speed, the rate of change of the magnetic flux in the sensor 18 is more and resulting voltage magnitude will also be higher. Accordingly, the voltage signal communicated to the controller 28 is indicative of the speed of the encoder gear 14.

In another example of the present invention, the sensor 18 is a Hall Effect type sensor. A typical Hall Effect sensor 18 includes a conductor having a constant current flowing through the conductor. When a magnetic field is introduced to the conductor, the magnetic field deflects the electrons from flowing directly across the conductor and results in a difference in the measured current. As the encoder gear 14 teeth 24 pass in front of the Hall Effect sensor 18, the resulting signal is converted to a speed signal by the controller 28. The Hall Effect sensor 18 is capable of measuring the strength of a magnetic field with high precision. Furthermore, because the Hall Effect sensor 18 does not rely upon the change in the strength of the magnetic flux to produce a signal, the Hall Effect sensor 18 provides the capability of measuring the speed of the encoder gear 14 at very low speeds or even detecting when the encoder gear 14 is stationary. Again, it should be appreciated that any type of sensor 18 may be employed that is operable to detect the teeth 24 of the encoder gear 14.

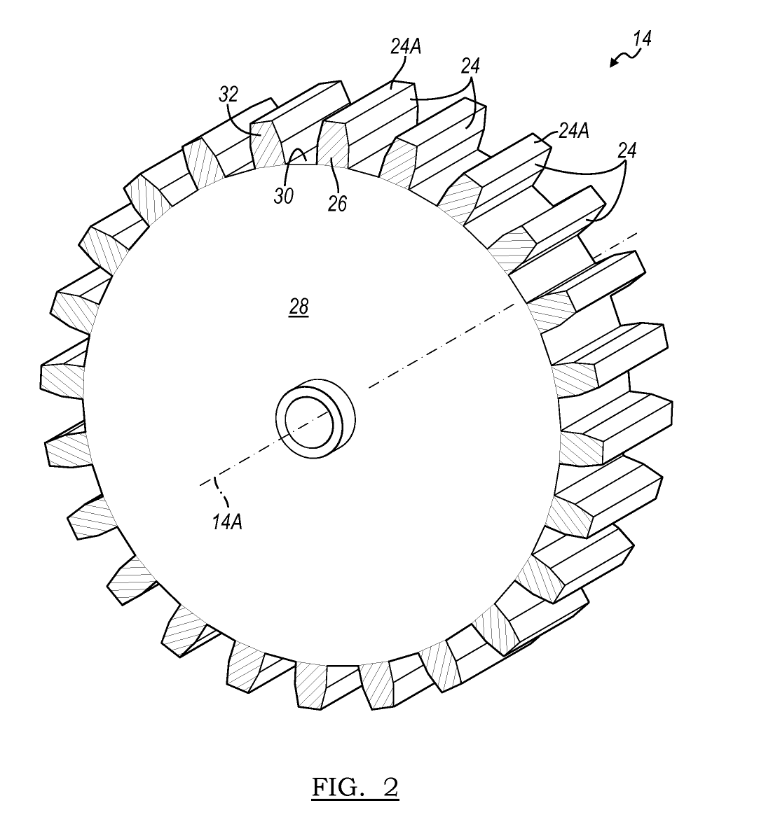

Referring now to FIG. 2, an example of an encoder gear 14 according to the present invention is illustrated. The encoder gear 14 may be modeled after a typical spur gear or another type of gear without departing from the scope of the present invention. The encoder gear 14 includes a disk-shaped body 28 and a plurality of gear teeth 24 disposed on the outer periphery 30 of the body 28. In the example provided, the each gear tooth 24 has an edge 24A parallel to the edge 24A of the adjacent gear tooth 24. However, the invention also contemplates other teeth and gear arrangements such as a helical gear which has angled or pitched gear teeth. Preferably, the gear teeth 24 have a target surface 26 extending radially in a direction perpendicular to the axis of rotation 14A of the encoder gear 14. The target surface 26 of each gear tooth 24 is configured to generate a magnetic field. More specifically, each target surface 26 is formed from a magnet or treated to generate a magnetic field. Furthermore, the magnetic field of the target surface 26 may alternate in polarity on successive or adjacent gear teeth 24. For example, any two adjacent gear teeth 24 may have an opposite polarity.

One method for achieving a target surface having a magnetic field includes applying a coating 32 to the target surface 26. The coating 32 contains particles capable of being magnetized. Such a coating 32 is commercially available from Freudenberg NOK of Plymouth, Mich. However, alternative methods and mechanisms may be used to magnetize the target surface 32 without departing from the scope of this invention. For example, another method for magnetizing the target surface 26 includes manufacturing the encoder gear 14 from a ferrous material and magnetizing the target surface 26 of each gear tooth 24 of the encoder gear 14. Such a method is commercially available from Methode Electronic Inc. of Chicago, Ill.

The elimination of an encoder wheel in assemblies such as transmissions provide, among other considerations, improved packaging opportunities, lighter weight assemblies and improved manufacturability. Using the encoder gear 14 as a target for a speed sensor 18 also provides a more accurate signal over targeting an encoder wheel. The use of an unbiased sensor 18 provides cost opportunities as well as packaging and reliability improvements. Furthermore, utilizing the target surface 26 as the sensor target instead of the radial surface again serves as a packaging improvement.

The description of the disclosure is merely exemplary in nature and variations that do not depart from the gist of the disclosure are intended to be within the scope of the disclosure. Such variations are not to be regarded as a departure from the spirit and scope of the disclosure.

What is claimed is:

1. A sensor assembly comprising:
a housing;
a first shaft rotatably supported by the housing;
a first gear having a plurality of gear teeth with each having a target surface and wherein the first gear is rotatably supported by the first shaft; and
a sensor mounted to the housing and wherein the sensor has a first end opposing the target surfaces of the plurality of gear teeth; and
wherein the target surfaces of the plurality of gear teeth of the first gear generates a magnetic field.

2. The sensor assembly of claim 1 further comprising:
a second shaft rotatably supported by the housing;
a second gear including a plurality of gear teeth, wherein the second gear is rotatably supported by the second shaft and wherein the plurality of gear teeth of the second gear are intermeshed with the plurality of gear teeth of the first gear.

3. The sensor assembly of claim 1 wherein the target surface of the plurality of gear teeth of the first gear includes a coating having a magnetic material that generates the magnetic field.

4. The sensor assembly of claim 1 wherein the target surfaces of the gear teeth of the first gear are formed of a magnetic material.

5. The sensor assembly of claim 1 wherein the magnetic field of the target surfaces of consecutive gear teeth alternate polarity.

6. The sensor assembly of claim 1 wherein the sensor is unbiased.

7. The sensor assembly of claim 1 wherein the first gear is a spur gear.

8. The sensor assembly of claim 1 wherein the first gear is a helical gear.

9. The sensor assembly of claim 1 wherein the sensor is a Hall Effect type sensor.

10. A sensor assembly comprising:
a housing;
a first and a second shaft rotatably supported by the housing;
a first gear having a plurality of gear teeth with each having a target surface and wherein the first gear is rotatably supported by the first shaft; and
a second gear including a plurality of gear teeth, wherein the second gear is rotatably supported by the second shaft and wherein the plurality of gear teeth of the second gear are intermeshed with the plurality of gear teeth of the first gear;
a sensor mounted to the housing and wherein the sensor has a first end opposing the target surfaces of the plurality of gear teeth; and
wherein the target surfaces of the plurality of gear teeth of the first gear generates a magnetic field.

11. The sensor assembly of claim 10 wherein the target surface of the plurality of gear teeth of the first gear includes a coating having a magnetic material that generates the magnetic field.

12. The sensor assembly of claim 10 wherein the target surfaces of the gear teeth of the first gear are formed of a magnetic material.

13. The sensor assembly of claim 10 wherein the magnetic field of the target surfaces of consecutive gear teeth alternate polarity.

14. The sensor assembly of claim 10 wherein the sensor is unbiased.

15. The sensor assembly of claim 10 wherein the first gear is a spur gear.

16. The sensor assembly of claim 10 wherein the sensor is a Hall Effect type sensor.

17. A sensor assembly comprising:
a housing;
a first and a second shaft rotatably supported by the housing;
a first gear having a plurality of gear teeth with each having a target surface and wherein the first gear is rotatably supported by the first shaft; and
a second gear including a plurality of gear teeth, wherein the second gear is rotatably supported by the second shaft and wherein the plurality of gear teeth of the second gear are intermeshed with the plurality of gear teeth of the first gear;
a sensor mounted to the housing and wherein the sensor has a first end opposing the target surfaces of the plurality of gear teeth; and
wherein the target surfaces of the plurality of gear teeth of the first gear is formed from a magnetic material that generates a magnetic field and wherein the magnetic field of the target surfaces of consecutive gear teeth alternate polarity.

18. The sensor assembly of claim 17 wherein the target surface of the plurality of gear teeth of the first gear includes a coating having a magnetic material that generates the magnetic field.

19. The sensor assembly of claim 17 wherein the target surface of the gear teeth of the first gear are formed of a magnetic material.

20. The sensor assembly of claim 17 wherein the sensor is unbiased.
